(19) United States
(12) Patent Application Publication
(10) Pub. No.: US 2022/0282047 A1
(43) Pub. Date: Sep. 8, 2022

(54) METHOD OF MAKING A HOMOGENEOUS MIXTURE OF POLYOLEFIN SOLIDS AND AN ORGANIC PEROXIDE

(71) Applicant: Dow Global Technologies LLC, Midland, MI (US)

(72) Inventors: Saurav S. Sengupta, Gilbertsville, PA (US); Timothy J. Person, Pottstown, PA (US); Paul J. Caronia, Annadale, NJ (US); Neil W. Dunchus, Collegeville, PA (US)

(21) Appl. No.: 17/635,720

(22) PCT Filed: Aug. 26, 2020
(86) PCT No.: PCT/US2020/047940

§ 371 Date: Feb. 16, 2022

Related U.S. Application Data
(60) Provisional application No. 63/068,108, filed on Aug. 20, 2020.
(60) Provisional application No. 62/893,258, filed on Aug. 29, 2019.
(60) Provisional application No. 62/893,249, filed on Aug. 29, 2019.

(51) Int. Cl. C08J 3/20; B29B 7/08; B29B 7/82; B29B 7/90

(52) U.S. Cl. CPC C08J 3/203; B29B 7/08; B29B 7/823; B29B 7/90; C08J 2323/06; B29K 2023/0633

(57) ABSTRACT

A method of making a homogeneous mixture of polyolefin solids and an organic peroxide without melting the polyolefin solids during the making. The method comprises applying acoustic energy at a frequency of from 20 to 100 hertz to a heterogeneous mixture comprising the polyolefin solids and the organic peroxide for a period of time sufficient to substantially intermix the polyolefin solids and the organic peroxide together while maintaining temperature of the heterogeneous mixture below the melting temperature of the polyolefin solids, thereby making the homogeneous mixture without melting the polyolefin solids.

### FIELD

Mixing polyolefins with additives.

### INTRODUCTION

Patents and patent application publications in or about the field include U.S. Pat. Nos. 6,565,784; 7,188,993 B1; 7,468,404 B2; 7,695,817 B2; 8,124,309 B2; 8,435,714 B2; 8,680,177 B2; 8,889,331 B2; 9,223,236 B2; 9,593,919 B2; 9,926,427 B2; 9,957,360 B2; and 10,513,625 B2. Non-patent publications in or about the field include Assessment of extrusion-sonication process on flame retardant polypropylene by rheological characterization, by G. Sanchez-Olivares, et al. AIMS Materials Science, 2016; vol. 3, no. 2, pages 620 to 633; and ENHANCED DISPERSION OF PARTICLE ADDITIVE INTO POLYMERS USING TWIN SCREW EXTRUSION WITH ULTRASOUND ASSISTANCE, by K. Tarverdi, et al., SPE ANTEC Anaheim 2017, pages 1058 to 1062.

Prior methods of mixing polyolefins with additives rely on mechanical blending of fluidized melts (e.g., in a twin-screw extruder device). That method can be harmful to organic peroxides, which degrade or decompose rapidly at temperatures of such fluidized melts (e.g., 180° to 220° C. for polyethylenes). Instead, after blending a fluidized melt of a polyolefin with additives other than peroxides, the resulting mixture is pelletized to give ambient temperature pellets. The pellets are then heated to a soaking temperature, and the heated pellets are soaked, a passive process, with a liquid organic peroxide or with a melt of a low-melting organic peroxide. The soaking temperature for soaking a liquid organic peroxide may be from 30° to 110° C. The solid organic peroxide used in the soaking method may have a melting point from 30° to 100° C., and the soaking temperature is from a temperature greater than the melting point of the solid organic peroxide to 110° C. For example, dicumyl peroxide melts at 39° to 41° C., and the soaking temperature may be from about 50° to 90° C., typically from 60° to 80° C. In commercial plants, pellets are placed in large bins and soaked with organic peroxide, taking from 10 to 16 hours to fully wet the polyolefin solids with the organic peroxide.

### SUMMARY

We have discovered a method of making a homogeneous mixture of polyolefin solids and an organic peroxide without melting the polyolefin solids during the making. The method comprises applying acoustic energy at a frequency of from 20 to 100 hertz to a heterogeneous mixture comprising the polyolefin solids and the organic peroxide for a period of time sufficient to substantially intermix the polyolefin solids and the organic peroxide together while maintaining temperature of the heterogeneous mixture (and, for that matter, the temperature of the homogeneous mixture made therefrom) below the melting temperature of the polyolefin solids, thereby making the homogeneous mixture without melting the polyolefin solids.

The method achieves thorough intermixing of the polyolefin solids and the organic peroxide without mechanical blending or melting the polyolefin solids and does so rapidly relative to a soaking method.

### DETAILED DESCRIPTION

A method of making a homogeneous mixture of polyolefin solids and an organic peroxide without melting the polyolefin solids during the making. The method comprises applying acoustic energy at a frequency of from 20 to 100 hertz to a heterogeneous mixture comprising the polyolefin solids and the organic peroxide for a period of time sufficient to substantially intermix the polyolefin solids and the organic peroxide together while maintaining temperature of the heterogeneous mixture (and, for that matter, the temperature of the homogeneous mixture made therefrom) below the melting temperature of the polyolefin solids, thereby making the homogeneous mixture without melting the polyolefin solids. The method comprises a mixing step consisting essentially of the applying acoustic energy step. This means the method achieves thorough intermixing of the polyolefin solids and the organic peroxide without mechanical blending or melting the polyolefin solids and does so rapidly relative to soaking, e.g., in less than 10 minutes.

Additional inventive aspects follow; some are numbered below for ease of reference.

Aspect 1. A method of making a homogeneous mixture of polyolefin solids and organic peroxide without melting the polyolefin solids during the making, the method comprising applying acoustic energy at a frequency of from 20 to 100 hertz (Hz) to a heterogeneous mixture comprising (A) polyolefin solids and (B) organic peroxide for a period of time sufficient to substantially intermix (thoroughly or completely homogenize) the (A) polyolefin solids and the (B) organic peroxide together while maintaining temperature of the heterogeneous mixture (and, for that matter, the temperature of the homogeneous mixture made therefrom) below the melting temperature of the (A) polyolefin solids, thereby making the homogeneous mixture without melting the (A) polyolefin solids; wherein the (A) polyolefin solids are from 95.0 to 99.9 weight percent (wt %) and the (B) organic peroxide is from 0.1 to 5.0 wt %, respectively, of the combined weights of the constituents (A) and (B). The heterogeneous mixture, and the homogeneous mixture made therefrom by the applying acoustic energy step, may comprise 0, 1, 2, or more optional additives. The total weight of all the constituents of the heterogeneous mixture, including any optional additives, is 100.0 wt % and the total weight of all constituents of the homogeneous mixture, including any optional additives, is 100.0 wt %. The method may further comprise the limitation wherein the heterogeneous mixture is not mechanically agitated (not mixed by mechanical means) during the applying acoustic energy step. The method may further comprise the limitation wherein the organic peroxide is not decomposed or degraded during the acoustic mixing step (as indicated by curing and/or mechanical properties).

Aspect 2. The method of aspect 1 wherein the applying acoustic energy step is characterized by any one of limitations (i) to (v): (i) the frequency is from 50 to 70 Hz, alternatively from 55 to 65 Hz, alternatively from 58 to 62 Hz, alternatively from 59 to 61 Hz; (ii) the period of time is from 0.5 minute to 4 hours, alternatively from 0.5 minute to 2 hours, alternatively from 1 minute to 60 minutes, alternatively from 1 minute to 10 minutes; (iii) both (i) and (ii); (iv) the maintaining temperature of the heterogeneous mixture below the melting temperature of the (A) polyolefin solids comprises maintaining temperature of the heterogeneous mixture (and, for that matter, the temperature of the homogeneous mixture made therefrom) at from −20° to 109° C., alternatively from 10° to 109° C., alternatively from 15° to 99° C., alternatively from −20° to 50.0° C., alternatively from 20.0° to 39.9° C., alternatively from 20.0° to 29.9° C. (e.g., 25° C.±3° C.); and (v) both (iv) and any one of (i) to (iii). The temperature may be ambient outdoor temperature. The intensity is sufficient to move materials with sufficient amplitude that is effective for mixing without mechanical agitation. An acoustic mixer device may be used to perform the applying acoustic energy step, wherein the frequency is set by the operator of the acoustic mixer device.

Aspect 3. The method of aspect 1 or 2 wherein the (A) polyolefin solids are characterized by a physical form (i.e., solid particulate form) that is a powder, granules, pellets, or a blend of any two or more thereof, and by a melting temperature that is from 61° to 180° C., alternatively from 90° to 180° C., alternatively from 110° to 174° C., alternatively from 120° to 180° C.; and the (B) organic peroxide is a liquid organic peroxide or a solid organic peroxide. The solid organic peroxide may be in the form of a powder or granules and may have a melting temperature that is from 24° to 120° C.; alternatively from 35° to 120° C.

Aspect 4. The method of any one of aspects 1 to 3 wherein the polyolefin of the (A) polyolefin solids consists essentially of one or more ethylene-based polymers; wherein each ethylene-based polymer is a low-density polyethylene (LDPE) polymer or a combination of the LDPE polymer and a polyolefin selected from the group consisting of: a second LDPE polymer; a linear low-density polyethylene (LLDPE) polymer; and a high-density polyethylene (HDPE) polymer. In other embodiments the polyolefin of the (A) polyolefin solids consists essentially of an LDPE and a polypropylene (PP) polymer.

Aspect 5. The method of any one of aspects 1 to 4 wherein the organic peroxide is a solid organic peroxide. In some embodiments the solid organic peroxide is selected from: dicumyl peroxide, dilauryl peroxide, dibenzoyl peroxide, and di-2-tert-butylperoxy isopropyl benzene, and alpha,alpha-Bis(t-butylperoxy)diisopropylbenzene. In some embodiments the (B) organic peroxide is a solid organic peroxide having a melting point T_{S}, wherein T_{S} is greater than 35° C., and the temperature of the heterogeneous mixture and homogeneous mixture independently is from −20° C. to <T_{S}, alternatively from 10° C. to <T_{S}, alternatively from 15° C. to <T_{S}, alternatively from 20.0° C. to <T_{S}. In some embodiments the (B) organic peroxide is a solid organic peroxide having a melting point T_{S}, wherein T_{S} is less than 109° C., and the temperature of the heterogeneous mixture and homogeneous mixture independently is from >T_{S} to 109° C., alternatively from >T_{S} to 99° C., alternatively from >T_{S} to 79° C., alternatively from >T_{S} to 50° C., alternatively from >T_{S} to 38° C.

Aspect 6. The method of any one of aspects 1 to 5 wherein the heterogeneous mixture further comprises one or more additives that is/are not the (A) polyolefin solids or the (B) organic peroxide, and the applying acoustic energy step comprises applying acoustic energy at a frequency of from 20 to 100 hertz (Hz) to the heterogeneous mixture comprising the (A) polyolefin solids, the (B) organic peroxide, and the one or more additives that do not include a peroxide for a period of time sufficient to substantially intermix (thoroughly or completely homogenize) the (A) polyolefin solids, the (B) organic peroxide, and the one or more additives together while maintaining temperature of the heterogeneous mixture (and, for that matter, the temperature of the homogeneous mixture made therefrom) below the melting temperature of the (A) polyolefin solids, thereby making the homogeneous mixture further comprising the one or more additives, without melting the (A) polyolefin solids. In some embodiments the one or more additives are separate ingredients in the heterogeneous mixture and not contained in the (A) polyolefin solids. In other embodiments at least one of the one or more additives is pre-blended into the (A) polyolefin solids via melt mixing and pelletizing such that the heterogeneous mixture comprises the (B) organic peroxide and composite solids (e.g., pellets) comprising the (A) polyolefin in admixture with the one or more additives.

Aspect 7. The method of aspect 6 wherein at least one, alternatively all but one, alternatively each of the one or more additives that is not constituents (A) or (B) is independently a liquid additive or particulate solid additive independently selected from additives (C) to (D): a liquid or particulate solid (C) antioxidant; and a liquid or particulate solid (D) stabilizer for stabilizing the homogeneous mixture against effects of ultraviolet light and/or heat. In some embodiments the one or more additives may further comprise at least one of a colorant, a crosslinking coagent for increasing crosslink density in a crosslinked homogeneous mixture made by heating the homogeneous mixture, a processing aid, a flame retardant, and a solid filler.

Aspect 8. The method of aspect 7 wherein the one or more additives include one or more of solid antioxidant (C)-1: tris[(4-tert-butyl-3-hydroxy-2,6-dimethylphenyl)methyl]-1,3,5-triazine-2,4,6-trione (“TMTT”); solid antioxidant (C)-2: distearyl thiodipropionate (“DSTDP”); and solid stabilizer (D)-1: N,N′-bisformyl-N,N′-bis(2,2,6,6-tetramethyl-4-piperidinyl)-hexamethylenediamine (“BBHMDA”).

Aspect 9. The method of any one of aspects 1 to 8 further comprising, before the applying acoustic energy step, a step of melting the (A) polyolefin solids to make a melt thereof, and mechanically blending the melt of (A) with one or more additives that are not (B) organic peroxide to give a melt mixture that is free of (B) organic peroxide; shaping the melt mixture to give a shaped melt mixture; and cooling the shaped melt mixture to give the (A) polyolefin solids containing one or more additives; and combining the (A) polyolefin solids containing one or more additives with the (B) organic peroxide to give the heterogeneous mixture. The shaping step may comprise extruding the melt mixture as a coating (e.g., a jacketing composition) onto a conductive core (e.g., a wire, fiber optic, or both), and allowing the coating to solidify to make a coated (e.g., jacketed) conductor comprising the conductive core and a coating-shaped solid at least partially covering (e.g., jacketing) the conductive core.

Aspect 10. The method of any one of aspects 1 to 9 further comprising curing the homogeneous mixture (e.g., by heating same to a temperature of 180° to 220° C.) to give a crosslinked homogeneous product.

The method comprises a mixing step consisting essentially of the applying acoustic energy step. This means the method achieves thorough intermixing of the polyolefin solids and the organic peroxide without mechanical blending or melting the polyolefin solids and does so rapidly relative to soaking, e.g., in less than 10 minutes. Embodiments of the method are free of soaking the polyolefin solids with the organic peroxide in that they initiate the applying acoustic energy step soon after contacting the polyolefin solids and organic peroxide together, e.g., within from 0 to 10 minutes, alternatively from 0.1 to 5 minutes, alternatively from 0.1 to 1 minute of the contacting.

Embodiments of the method may further include in the heterogeneous mixture, and thus in the homogeneous mixture made therefrom by the applying acoustic energy step, the one, two or more additives, e.g., the one or more liquid and/or solid additives such as the liquid or particulate solid (C) antioxidant(s) and/or the liquid or particulate solid (D) stabilizer. Such embodiments have an additional benefit of making the homogeneous mixture comprising the (A) polyolefin solids, the (B) organic peroxide, and the one, two, or more additives without mechanical blending or melting the (A) polyolefin solids. That is the (A) polyolefin solids of the inventive homogeneous mixture have an improved (decreased) thermal exposure relative to a comparative thermal exposure of (A) polyolefin solids of a comparative homogeneous mixture that has been made by a comparative method comprising melt blending the (A) polyolefin solids and the one, two or more additives to give a melt blend; extruding/pelletizing the melt blend to give solid pellets comprising a homogeneous mixture of the (A) polyolefin solids and the one, two or more additives; and soaking the (B) organic peroxide into the pellets. These inventive embodiments also have a further benefit of making the inventive homogeneous mixture a lot faster than the comparative method makes the comparative homogeneous mixture (e.g., within 10 minutes versus several hours, respectively).

The method solves a problem of mixing of polyolefin solids with organic peroxide without melting the polyolefin solids, without soaking the organic peroxide into the polyolefin solids, and, optionally, without using mechanical mixing means. The applying acoustic energy step can achieve such thorough and rapid intermixing without melting the polyolefin solids. If desired, the method may be performed without mechanical mixing.

The applying acoustic energy step enables and is effective for thoroughly and rapidly intermixing of the (A) polyolefin solids and the (B) organic peroxide without melting the polyolefin solids during the intermixing. This combination of advantages of mixing completeness, mixing speed, and minimizing thermal exposure are discussed below. Embodiments of the method that omit mechanical mixing means beneficially avoid using expensive mechanical mixing equipment and simplify manufacturing operations.

The intermixing of the applying acoustic energy step is thorough because it achieves and makes a homogeneous mixture. In a practical sense achieving the homogeneity may be recognized be visual inspection or by sampling of the mixture as it transitions from a heterogeneous to a homogeneous state, and measuring a property of the sample. For example, homogeneity is achieved when the sampling error of the measurement is negligible or identical compared to the total error of the measurement. All other things being equal, (i) the greater the acoustic energy, the shorter the period of time needed to achieve homogeneity, and vice versa; and (ii) the closer is the frequency to a resonating with the polymer solids, the shorter the period of time needed to achieve homogeneity, and vice versa.

The intermixing of the applying acoustic energy step is rapid because complete intermixing can be achieved in a matter of seconds or minutes, e.g., from 0.5 minute to 10 minutes, alternatively from 1.0 to 5.0 minutes, alternatively from 2 to 4 minutes.

The applying acoustic energy step minimizes thermal exposure of the homogeneous mixture because it converts the heterogeneous mixture to the homogeneous mixture without melting the (A) polyolefin solids. In fact, if desired, may be advantageously conducted at a temperature well below the melting temperature of the (A) polyolefin solids. For example, the applying acoustic energy step may be carried out at a temperature from 0° to 39° C., alternatively from 10° to 34° C., alternatively from 20° to 30° C.

Because the applying acoustic energy step may be conducted at a temperature far below the melting temperature of the (A) polyolefin solids, embodiments of the step may advantageously be conducted in oxygen-containing atmosphere such as air. Oxygen-containing atmospheres may be harmful to conventional melt-mixing or melt-compounding operations wherein exposing a melt of the (A) polyolefin solids containing the (B) organic peroxide and optionally additives to air at high temperatures such as 140° to 200° C. could undesirably cause scorch (premature curing) or oxidative—and/or—thermal decomposition of the (A) polyolefin solids and/or additives. Thus, the applying acoustic energy step beneficially maintains the temperature of the (A) polyolefin solids, and of the other constituents of the heterogeneous mixture containing same and the homogeneous mixture made therefrom, below the melting temperature of the (A) polyolefin solids.

Even in embodiments of the method that further comprise the step of melting and extruding the homogeneous mixture to give a shaped article, the homogeneous mixture has had less thermal exposure than has a comparative homogeneous mixture made by melt-mixing or melt-compounding the heterogeneous mixture. This is because it has avoided the melt-mixing/compounding exposure time, which would otherwise have added 10 or more minutes of exposure to temperatures of 140° C. or higher.

Thus, without being bound by theory, it is believed that relative to the comparative homogeneous mixture, the inventive homogeneous mixture may have improved cure properties (e.g., lower ML, higher MH, and/or higher MH-ML measured by the Cure Properties Test Method described later), improved mechanical properties (e.g., higher tensile strength, lower elongation-at-break) as measured by the Mechanical Properties Test Method described later, and/or improved heat aging performance.

These cure and mechanical properties characterizations show that the inventive homogeneous mixture may be prepared rapidly (in less than 10 minutes, e.g., 3 minutes) under mild temperatures (e.g., <30° C., e.g., 23° to 26° C.) and achieve loading levels of the (B) organic peroxide that are typically used for curing of polyolefins. Further, the inventive homogeneous mixture may be cured to give cure properties and mechanical properties that are improved relative those obtained from a comparative example that is made by a conventional two-step process comprising melt-blending polyolefin solids with all additives (except for organic peroxide) at 120° C. to give the an intermediate blend, then extruding strands thereof at 150° C./170° C./190° C./195° C., pelletizing, and soaking organic peroxide into the pellets at elevated temperature (70° C.) for an extended period of time (typically 8 to 10 hours). In fact as indicated by a lower starting ML value and an ultimate MH value, a higher MH-ML value, obtained by curing the inventive homogeneous mixture using a moving die rheometer, it can be concluded that the inventive acoustic mixing method decreases organic peroxide decomposition during preparation of the inventive homogeneous mixture relative to the preparation of the comparative melt blend/soaked mixture. As a result, it can also be seen that a greater extent of crosslinking of the inventive homogeneous mixture is achieved relative to that of the comparative melt-blend/soaked mixture. This inventive advantage is also reflected in the inventive cured product having a lower elongation-at-break value (i.e., higher crosslinking) than the comparative cured product.

A technical explanation of how the applying acoustic energy step makes the homogeneous mixture from the heterogeneous mixture without mechanical mixing is not required. Nevertheless, without being bound by theory, it is believed that the applying acoustic energy at the frequency of from 20 to 100 Hz generates sound waves that cause the (A) polyolefin solids and the (B) organic peroxide to oscillate rapidly. They experience a relatively large physical displacement, the magnitude and rapidity of which are believed to be a function of the frequency and acoustic intensity. This oscillating of the (A) polyolefin solids and the (B) organic peroxide results in their rapid intermixing to form the homogeneous mixture. The homogeneous mixture is thus made without melting the (A) polyolefin solids, and, optionally, without any mechanical mixing of (A) polyolefin solids and the (B) organic peroxide. Thus, the present method is distinct from prior mixing methods, which rely on mechanical blending of solids (e.g., in a stirred tank device) or melts (e.g., in a twin-screw extruder device) of polyolefins with (B) organic peroxide.

Sound having a frequency less than 20 Hertz (Hz) is called “infrasound”; and from 20 Hz to 20 kilohertz (KHz), “acoustic”; and greater than 20 KHz (up to 200 megahertz (MHz) or higher), “ultrasound”. Without being bound by theory it is believed that infrasound and ultrasound and acoustic sound above 100 Hz cannot, by itself, rapidly oscillate the (A) polyolefin solids or the (B) organic peroxide in the heterogeneous mixture in a way that would create the relatively large physical displacement thereof and thereby yield the homogeneous mixture. The applying acoustic energy at a frequency of from 20 to 100 Hz is called “acoustic mixing” herein.

To apply the effective acoustic energy by practical means, the method may make the homogeneous mixture in an acoustic mixer device. Such a device may be free of components that could interfere with or dampen the acoustic energy of the applying acoustic energy step. Acoustic mixer devices for various scale uses from lab bench to commercial manufacturing may be available commercially, including resonant acoustic mixers from Resodyn Acoustic Mixers, Butte, Mont., USA.

The method may further comprise a limitation without mechanically agitating (moving by mechanical means) the heterogeneous mixture during the applying acoustic energy step. Mechanically moving means putting in motion manually or via a machine via a direct contact force wherein a physical object (e.g., a stirrer paddle, a screw, a plunger, or a blender) touches and thereby moves a material. Examples of mechanically moving are stirring, screw mixing, plunger mixing, blender mixing, and other direct physically contacting. The contact force does not include electromagnetic force, gravity, acoustic force, and convective force.

In addition to the applying acoustic energy step, some embodiments of the method may further comprise one or more optional steps. Typically, the optional step does not occur at the same time as the applying acoustic energy step. An optional step may occur before the applying acoustic energy step, or after the acoustic energy step, as described herein.

The method may further comprise, after the applying acoustic energy step, a subsequent step of melting and shaping the homogeneous mixture made by the applying acoustic energy step, and cooling the shaped homogeneous mixture so as to make a manufactured article comprising the shaped homogeneous mixture.

The method may further comprise, after the applying acoustic energy step, the step of melting the (A) polyolefin solids of the homogeneous mixture to make a homogeneous melt mixture comprising the (B) organic peroxide, one or more additives, if present, and a melt of the (A) polyolefin solids; shaping the homogeneous melt mixture to give a shaped melt mixture; and cooling the shaped melt mixture to give a shaped solid. The melting and shaping may be free of mechanical agitating, alternatively may employ mechanical agitating. The shaping may comprise coating, extruding, molding, pelletizing, or extruding and pelletizing. In some embodiments the shaping comprises extruding the homogeneous melt mixture, and pelletizing the extrudate to make pellets of the homogeneous mixture. The shaped solid may be useful as manufactured article. The manufactured article may be a coating layer of a coated conductor such as a telecommunications or power cable.

The method may further comprise the optional step of curing (crosslinking) the coating-shaped solid so as to give a coated conductor comprising the conductive core and a coating-shaped cured product at least partially covering the conductive core. This aspect may be used to make a manufactured article comprising a power cable such as a low voltage power cable.

The method may further comprise, before the applying acoustic energy step, an optional step of making the heterogeneous mixture. The heterogeneous mixture may be made by contacting the (A) polyolefin solids with the (B) organic peroxide, and, optionally, one or more additives, so as to make the heterogeneous mixture comprising the constituents (A) and (B) and, if present, the one or more additives. The contacting step is performed in the absence of acoustic energy and, ideally, without melting the (A) polyolefin solids.

The contacting of constituents (A) and (B) and, optionally, the one or more additives to make the heterogeneous mixture may be done simultaneously (all at once) or sequentially, or a combination of some all at once and the rest sequentially (stepwise). The simultaneous contacting may comprise combining the constituents (A), (B), and any one or more additives together at the same time in a container to make the heterogeneous mixture.

The stepwise contacting may comprise different embodiments. In some embodiments the sequential contacting may comprise contacting the (B) organic peroxide with at least one of the one or more additives to give a first precontacted batch that is free of (A), and then contacting the (A) polyolefin solids with the first precontacted batch to make the embodiment of the heterogeneous mixture comprising (A), (B), and the one or more additives.

Alternatively, the sequential contacting may comprise contacting the (A) polyolefin solids with at least one of the one or more additives to give a second precontacted batch that is free of (B), and then contacting the (B) organic peroxide with the second precontacted batch to make the embodiment of the heterogeneous mixture of (A), (B), and the one or more additives.

Alternatively, a combination of the two forgoing sequential embodiments may be performed using a first additive to make the first precontacted batch and a second additive to make the second precontacted batch, wherein the first and second additives are same or different, and then contacting the first and second precontacted batches together to make the embodiment of the heterogeneous mixture comprising (A), (B), and the one or more additives.

Prior to the contacting step, the (A) polyolefin solids used to make the embodiment of the heterogeneous mixture may be free of the (B) organic peroxide, and vice versa the (B) organic peroxide used may be free of the (A) polyolefin solids. Alternatively in some embodiments a masterbatch comprising a higher than final loading of the (B) organic peroxide dispersed in a portion of the (A) polyolefin solids may be premade, and then the masterbatch may be contacted with the remaining portion of the (A) polyolefin solids to make the heterogeneous mixture. The same or a different masterbatch may be comprise the one or more additives, which may be contacted with a remaining portion of the (A) polyolefin solids and the (B) organic peroxide to make that embodiment of the heterogeneous mixture. The masterbatch may be made by acoustic mixing or conventional melt-mixing.

The (A) polyolefin solids used in the contacting step, for making the heterogeneous mixture, may be free of the one or more additives (e.g., the (A) polyolefin solids may consist of granules or pellets of virgin polyolefin resin). Alternatively, the (A) polyolefin solids used in the contacting step, for making the heterogeneous mixture, may contain some or all of the one or more additives, such as one or more antioxidants and heat stabilizers. These additives may have been premixed into granules or pellets of virgin polyolefin resin via melt mixing or melt compounding the virgin resin so as to make the (A) polyolefin solids containing one or more antioxidants and heat stabilizers.

The heterogeneous mixture used in the step of applying acoustic energy may be freshly prepared by such contacting step. The “freshly prepared” means that the time between the contacting step and start of the applying acoustic energy step may be less than 30 minutes, alternatively less than 15 minutes, alternatively less than 10 minutes, alternatively less than 5 minutes. Alternatively, the heterogeneous mixture used in the step of applying acoustic energy may be pre-aged. The “pre-aged” means that the time between the contacting step and start of the applying acoustic energy step may be at least 30 minutes, alternatively greater than 60 minutes, alternatively greater than 120 minutes.

The homogeneous mixture is made by the applying acoustic energy step of the method. The homogeneous mixture may be characterized as such as described earlier. Without being bound by theory, the product of that step may be characterized as homogeneous in that the (B) organic peroxide are substantially uniformly adsorbed on exterior surfaces, and any accessible interior surfaces, of the (A) polyolefin solids. The “substantially uniformly adsorbed” means virtually all accessible surfaces of the (A) polyolefin solids have at least some (B) organic peroxide adsorbed thereon, although the amounts of adsorbed (B) organic peroxide may vary across the surfaces. Once adsorbed on surfaces of the (A) polyolefin solids, the (B) organic peroxide may remain thereon until, in an optional subsequent step, the (A) polyolefin solids are melted.

When the heterogeneous mixture, and the homogeneous mixture made therefrom, includes the one or more additives, the (A) polyolefin solids may be from 50 to 99.8 weight percent (wt %), the (B) organic peroxide may be from 0.1 to 5.0 wt %, and the total weight of the one or more additives may be from 0.1 to 45 wt %, all based on the weight of the homogeneous mixture and homogeneous mixture, respectively; and wherein the total weight of all the constituents of the heterogeneous mixture is 100.0 wt % and the total weight of all constituents of the homogeneous mixture is 100.0 wt %.

Without being bound by theory, it is believed that the total weight of the homogeneous mixture is equal to the total weight of the heterogeneous mixture from which it is made. That is, it is believed that the applying acoustic energy step does not result in any significant loss or gain of weight going from the heterogenous mixture to the homogeneous mixture.

The (A) polyolefin solids. A finely-divided, solid-state matter composed of polyolefin macromolecules that independently comprise at least 5, alternatively from 10 to 200,000 constituent units derived from polymerizing one or more olefin-functional monomers.

The polyolefin may be a homopolymer or a copolymer. The homopolymer is made by polymerizing only one olefin monomer. The copolymer is made by polymerizing at least two different olefin monomers. The copolymer may be a bipolymer made by polymerizing two different olefin monomers, a terpolymer made by polymerizing three different olefin monomers, or a tetrapolymer made by polymerizing four different olefin monomers. The polyolefin that is a copolymer may be a block copolymer or a random copolymer.

Examples of the olefin-functional monomers used to make the polyolefin(s) of the (A) polyolefin solids are ethylene, propene, (C₄-C₂₀)alpha-olefins, cyclic alkenes (e.g., norbornene), dienes (e.g., 1,3-butadiene), unsaturated carboxylic esters, and olefin-functional hydrolyzable silanes. Examples of the (C₄-C₂₀)alpha-olefin are a (C₄-C₈)alpha-olefin such as 1-butene, 1-hexene, or 1-octene; and a (C₁₀-C₂₀)alpha-olefin. Example of the diene is 1,3-butadiene. Examples of the unsaturated carboxylic esters are alkyl acrylates, alkyl methacrylates, and vinyl carboxylates (e.g., vinyl acetate). Examples of the olefin-functional hydrolyzable silanes are vinyltrialkoxysilanes, vinyltris(dialkylamino)silanes, and vinyl(trioximo)silanes.

Examples of such polyolefins are a polyethylene homopolymer; an ethylene/alpha-olefin copolymer; a (hydrolyzable silyl group)-functional polyethylene copolymer (HSG-FP Copolymer); an ethylene/unsaturated carboxylic ester copolymer (e.g., ethylene/vinyl acetate (EVA) copolymer or ethylene/alkyl (meth)acrylate (EAA or EAM) copolymer); a halogenated polyolefin (e.g., a chlorinated polyolefin such as a poly(vinyl chloride) polymer), and a combination of any two or more thereof.

In some embodiments the polyolefin of the (A) polyolefin solids is an ethylene-based polymer. An ethylene-based polymer comprises from 51 to 100 wt % of ethylenic units derived from polymerizing ethylene and from 49 to 0 wt % of comonomeric units derived from polymerizing one, alternatively two olefin-functional monomer (comonomer). The comonomer may be selected from propylene, a (C₄-C₂₀)alpha-olefin, and 1,3-butadiene. The (C₄-C₂₀)alpha-olefin may be a (C₄-C₈)alpha-olefin such as 1-butene, 1-hexene, or 1-octene.

Examples of suitable ethylene-based polymers are polyethylene homopolymers, ethylene/(C₄-C₂₀)alpha-olefin copolymers, ethylene/propylene copolymers, ethylene/propylene/diene monomer (EPDM) copolymers such as an ethylene/propylene/1,3-butadiene terpolymer, and ethylene/1-butene/styrene copolymers. Examples of suitable ethylene/(C₄-C₂₀)alpha-olefin copolymers are ethylene/1-butene copolymers, ethylene/1-hexene copolymers, and ethylene/1-octene copolymers. The ethylene-based polymers may be an ultra-low-density polyethylene (ULDPE), very low-density polyethylene (VLDPE), a linear low-density polyethylene (LLDPE), a low-density polyethylene (LDPE), a medium-density polyethylene (MDPE), a high-density polyethylene (HDPE), or an ultra-high-density polyethylene (UHDPE). Many of the ethylene-based polymers are sold by The Dow Chemical Company under trade names like AFFINITY, ATTANE, DOWLEX, ENGAGE, FLEXOMER, or INFUSE. Other ethylene-based polymers are sold by other suppliers under trade names like TAFMER, EXCEED, and EXACT.

In some embodiments the (A) polyolefin solids consist of solids of only one ethylene-based polymer (e.g., only LLDPE, or only LDPE, or only MDPE, or only HDPE).

In other embodiments the (A) polyolefin solids comprise two or more different ethylene-based polymers. In some such embodiments the (A) polyolefin solids comprises a particle blend of first solids of a first linear low-density polyethylene (first LLDPE) and at least one of second solids of a medium-density polyethylene (MDPE) and third solids of a second LLDPE that is different than the first LLDPE. In some embodiments the particle blend comprises the first LLDPE and the MDPE; alternatively the first LLDPE and the second LLDPE; alternatively each of the first LLDPE, the MDPE, and the second LLDPE.

In some embodiments the ethylene-based polymer that is free of halogen and silicon atoms is a polyethylene homopolymer, a poly(ethylene-co-1-butene) copolymer, a poly(ethylene-co-1-hexene) copolymer, a poly(ethylene-co-1-octene) copolymer, or a combination of any two or more thereof. In some such embodiments the polyolefin is a low-density polyethylene (LDPE), a linear low-density polyethylene (LLDPE), a medium-density polyethylene (MDPE), a high-density polyethylene (HDPE), or a combination of any two or more thereof (e.g., a combination of one LLDPE and one MDPE or a combination of two LLDPE and one MDPE).

In some embodiments the ethylene-based polymer is a low-density polyethylene (LDPE) having a density of from 0.915 to 0.924 g/cc and a melt index (I₂, 190° C., 2.16 kg) of 1.5 to 2.4 g/10 min.

The (A) polyolefin solids may consist essentially of only one polyolefin.

In some embodiments the (A) polyolefin solids consist essentially of two or three different polyolefins. Such embodiments of the (A) polyolefin solids may consist essentially of solids wherein each particle of the solids comprises a polymer blend of the two or more different polyolefins. Other such embodiments may comprise a particle blend of first solids consisting essentially of a first polyolefin only, second solids consisting essentially of a second polyolefin only, and, optionally, third solids consisting essentially of a third polyolefin only; wherein the first and second polyolefins, and, if present, the third polyolefin, are different than each other. Still other embodiments may comprise a particle blend of first solids consisting essentially of a first polyolefin only and second solids consisting essentially of a polymer blend of a second polyolefin and a third polyolefin; wherein the first and second polyolefins are different than each other and the first and third polyolefins are the same or different.

In some embodiments the polyolefin of the (A) polyolefin solids is free of halogen and/or silicon atoms. In some embodiments the polyolefin is also free of oxygen atoms and/or nitrogen atoms. In some embodiments the ethylene-based polymer is free of halogen and/or silicon atoms. In some embodiments the ethylene-based polymer is also free of oxygen atoms and/or nitrogen atoms. In other embodiments the ethylene-based polymer is free of halogen and/or silicon atoms and free of oxygen and nitrogen atoms derived from an oxygen-containing and/or nitrogen-containing olefin monomer, but contains crosslinks containing oxygen and/or nitrogen atoms derived from oxygen and/or nitrogen-containing crosslinking coagents (e.g., triallyl isocyanurate or 2,4,6-tris(diallylamino)-1,3,5-triazine).

In some embodiments the polyolefin of the (A) polyolefin solids is a propylene-based polymer comprising from 51 to 100 wt % of propylenic units derived from polymerizing propylene and from 49 to 0 wt % of comonomeric units derived from polymerizing one, alternatively two olefin-functional monomer (comonomer) selected from ethylene; a (C₄-C₈)alpha-olefin such as 1-butene, 1-hexene, or 1-octene.

The (A) polyolefin solids may be porous or non-porous. The (A) polyolefin solids may comprise a powder, granules, or pellets.

The (A) polyolefin solids may have a melting temperature at which melting begins or starts that is 60° C. or greater, alternatively greater than 100° C., alternatively greater than 110° C. The (A) polyolefin solids may have a melting temperature at which melting ends or completes of at most 220° C., alternatively at most 180° C., alternatively at most 150° C.

The (A) polyolefin solids of the heterogeneous mixture may be characterized by an average particle size of from 10 to 500 particles per gram (ppg), alternatively from 11 to 80 ppg, alternatively from 20 to 40 ppg, as measured by counting.

The (B) organic peroxide. A molecule containing carbon atoms, hydrogen atoms, and two or more oxygen atoms, and having at least one —O—O— group, with the proviso that when there are more than one —O—O— group, each —O—O— group is bonded indirectly to another —O—O— group via one or more carbon atoms; or collection of such molecules. The (B) organic peroxide may be used for curing the inventive homogeneous mixture by heating the homogeneous mixture to a temperature at or above the (B) organic peroxide's decomposition temperature.

The (B) organic peroxide may be a monoperoxide of formula R^{O}—O—O—R^{O}, wherein each R^{O} independently is a (C₁-C₂₀)alkyl group or (C₆-C₂₀)aryl group. Each (C₁-C₂₀)alkyl group independently is unsubstituted or substituted with 1 or 2 (C₆-C₁₂)aryl groups. Each (C₆-C₂₀)aryl group is unsubstituted or substituted with 1 to 4 (C₁-C₁₀)alkyl groups.

Alternatively, the (B) may be a diperoxide of formula R^{O}—O—O—R—O—O—R^{O}, wherein R is a divalent hydrocarbon group such as a (C₂-C₁₀)alkylene, (C₃-C₁₀)cycloalkylene, or phenylene, and each R^{O} is as defined above. The (D) organic peroxide may be bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1-dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(alpha-t-butyl-peroxyisopropyl) benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; or di(isopropylcumyl) peroxide; or dicumyl peroxide. The (B) organic peroxide may be dicumyl peroxide.

In some aspects only a blend of two or more (B) organic peroxides is used, e.g., a 20:80 (wt/wt) blend of t-butyl cumyl peroxide and bis(t-butyl peroxy isopropyl)benzene (e.g., LUPEROX D446B, which is commercially available from Arkema). In some aspects at least one, alternatively each (B) organic peroxide contains one —O—O— group.

The (B) organic peroxide may be at least one liquid organic peroxide (e.g., tert-butyl peroxyacetate). Alternatively, the (B) organic peroxide may be at least one solid organic peroxide (e.g., dicumyl peroxide). Alternatively, the (B) organic peroxide may be a combination of two liquid organic peroxides, two solid organic peroxides, or one liquid organic peroxide and one solid organic peroxide.

The liquid organic peroxide embodiment of (B) means any one of the organic peroxides of formula R^{O}—O—O—R^{O} or formula R^{O}—O—O—R—O—O—R^{O} that has an amorphous state of matter at ambient temperature (e.g., 23° C.) that is intermediate between a gas and a solid and having a stable volume, but not a defined shape. In some embodiments the liquid organic peroxide is tert-butyl peroxyacetate.

The solid organic peroxide embodiment of (B) means any one of the organic peroxides of formula R^{O}—O—O—R^{O} or formula R^{O}—O—O—R—O—O—R^{O} that has a state of matter at ambient temperature (e.g., 23° C.) that has a stable volume and defined shape. May be amorphous, crystalline, or semi-crystalline. In some embodiments the solid organic peroxide is selected from dicumyl peroxide, dilauryl peroxide, dibenzoyl peroxide, and di-2-tert-butylperoxy isopropyl benzene, and alpha,alpha-Bis(t-butylperoxy)diisopropylbenzene.

The (B) organic peroxide may be 0.05 to 3.0 wt %, alternatively 0.1 to 3 wt %, alternatively 0.5 to 2.5 wt % of the heterogeneous mixture and homogeneous mixture made therefrom.

The optional one or more additives. A substance that is not the (A) polyolefin solids or the (B) organic peroxide and is added to the heterogeneous mixture to improve one or more properties of the homogeneous mixture made therefrom. Without being bound by theory, it is believed that the applying acoustic energy step of the method does not decompose any additive such than if the heterogeneous mixture contains an additive, that additive will also be contained in the homogeneous mixture made from that heterogeneous mixture.

In some embodiments the heterogeneous mixture, and the homogeneous mixture made therefrom, is free of additives. In other embodiments the heterogeneous mixture, and the homogeneous mixture made therefrom contains 1 or more additives.

The homogeneous mixture may further comprise one or more additional additives that is/are not present in the heterogeneous mixture from which it was made, but are added to the homogeneous mixture after the applying acoustic energy step. The method of adding such additional additives may comprise melting the (A) polyolefin solids as in a melt mixing or melt compounding operation. Alternatively, the method of adding such additional additives may comprise a melting-free operation such as passively soaking or imbibing such additional additives into the homogeneous mixture at a temperature of from 20° to 90° C. (e.g., 50° to 80° C.). Liquid additives and particulate solid additives having a melting point less than 90° C. are useful for such soaking or imbibing methods.

In some embodiments the heterogeneous mixture, and the homogeneous mixture made therefrom contains 1 or more additives, alternatively 2 or more additives, alternatively 3 or more additives, alternatively 4 or more additives, alternatively 5 or more additives. In some embodiments the heterogeneous mixture, and the homogeneous mixture made therefrom contains a total of 10 or fewer additives, alternatively a total of 9 or fewer additives, alternatively a total of 8 or fewer additives, alternatively a total of 7 or fewer additives, alternatively a total of 6 or fewer additives.

In some embodiments at least one, alternatively all but one, alternatively each of the one or more additives that is not constituents (A) or (B) is independently a liquid or particulate solid additive selected from a liquid or particulate solid (C) antioxidant and a liquid or particulate solid (D) stabilizer for stabilizing the homogeneous mixture against effects of ultraviolet light and/or heat. In some embodiments the one or more additives may comprise a colorant (e.g., carbon black or TiO₂), a crosslinking coagent (e.g., triallyl isocyanurate (TAIC)); a processing aid (e.g., a fluoropolymer or polydimethylsiloxane); a flame retardant (an alumina), and/or a filler (e.g., fumed silica). Each additive independently may be a liquid additive or a particulate solid additive. In some embodiments the heterogeneous mixture, and the homogeneous mixture from which it was made, contains at least one particulate solid additive, alternatively at least one liquid additive, alternatively at least one particulate solid additive and at least one liquid additive.

Each particulate solid additive independently may have a melting point that is lower than, the same as, or higher than the melting temperature of the (A) polyolefin solids.

Optional liquid or particulate solid additive (C) antioxidant: an organic molecule that inhibits oxidation, or a collection of such molecules. The (C) antioxidant is different in composition than the (D) stabilizer, which means when the heterogeneous or homogeneous mixture contains both (C) and (D), the compound used as (C) is different than that used as (D). The (C) antioxidant functions to provide antioxidizing properties to the heterogeneous or homogeneous mixture and/or a cured polymer product made by curing the homogeneous mixture. Examples of suitable (C) are bis(4-(1-methyl-1-phenylethyl)phenyl)amine (e.g., NAUGARD 445); 2,2′-methylene-bis(4-methyl-6-t-butylphenol) (e.g., VANOX MBPC); 2,2′-thiobis(2-t-butyl-5-methylphenol (CAS No. 90-66-4; 4,4′-thiobis(2-t-butyl-5-methylphenol) (also known as 4,4′-thiobis(6-tert-butyl-m-cresol), CAS No. 96-69-5, commercially LOWINOX TBM-6); 2,2′-thiobis(6-t-butyl-4-methylphenol (CAS No. 90-66-4, commercially LOWINOX TBP-6); tris[(4-tert-butyl-3-hydroxy-2,6-dimethylphenyl)methyl]-1,3,5-triazine-2,4,6-trione (e.g., CYANOX 1790); pentaerythritol tetrakis(3-(3,5-bis(1,1-dimethylethyl)-4-hydroxyphenyl)propionate (e.g., IRGANOX 1010, CAS Number 6683-19-8); 3,5-bis(1,1-dimethylethyl)-4-hydroxybenzenepropanoic acid 2,2′-thiodiethanediyl ester (e.g., IRGANOX 1035, CAS Number 41484-35-9); distearyl thiodipropionate (“DSTDP”); dilauryl thiodipropionate (e.g., IRGANOX PS 800): stearyl 3-(3,5-di-t-butyl-4-hydroxyphenyl)propionate (e.g., IRGANOX 1076); 2,4-bis(dodecylthiomethyl)-6-methylphenol (IRGANOX 1726); 4,6-bis(octylthiomethyl)-o-cresol (e.g. IRGANOX 1520); and 2′,3-bis[[3-[3,5-di-tert-butyl-4-hydroxyphenyl]propionyl]] propionohydrazide (IRGANOX 1024). The (C) may be 4,4′-thiobis(2-t-butyl-5-methylphenol) (also known as 4,4′-thiobis(6-tert-butyl-m-cresol); 2,2′-thiobis(6-t-butyl-4-methylphenol; tris[(4-tert-butyl-3-hydroxy-2,6-dimethylphenyl)methyl]-1,3,5-triazine-2,4,6-trione; distearyl thiodipropionate; or dilauryl thiodipropionate; or a combination of any two or more thereof. The combination may be tris[(4-tert-butyl-3-hydroxy-2,6-dimethylphenyl)methyl]-1,3,5-triazine-2,4,6-trione and distearyl thiodipropionate. The heterogeneous and/or homogeneous mixture may be free of (C). When present, the (C) antioxidant may be from 0.01 to 1.5 wt %, alternatively 0.1 to 1.0 wt % of the total weight of the heterogeneous and/or homogeneous mixture.

Optional liquid or particulate solid additive (D) a stabilizer for stabilizing the heterogeneous and/or homogeneous mixture against ultraviolet light (UV stabilizer). The (D) stabilizer is different in composition than the (C) antioxidant, which means when the mixture contains both (C) and (D), the compound used as (C) is different than that used as (D). Examples are a hindered amine light stabilizer (HALS), a benzophenone, or a benzotriazole. The (D) UV stabilizer may be a molecule that contains a basic nitrogen atom that is bonded to at least one sterically bulky organo group and functions as an inhibitor of degradation or decomposition, or a collection of such molecules. The HALS is a compound that has a sterically hindered amino functional group and inhibits oxidative degradation and can also increase the shelf lives of the homogeneous mixture, which contains the (B) organic peroxide. Examples of suitable (D) are butanedioic acid dimethyl ester, polymer with 4-hydroxy-2,2,6,6-tetramethyl-1-piperidine-ethanol (CAS No. 65447-77-0, commercially LOWILITE 62); and N,N′-bisformyl-N,N′-bis(2,2,6,6-tetramethyl-4-piperidinyl)-hexamethylenediamine (CAS No. 124172-53-8, commercially Uvinul 4050 H). The heterogeneous and/or homogeneous mixture may be free of (D). When present, the (D) UV stabilizer may be from 0.001 to 1.5 wt %, alternatively 0.002 to 1.0 wt %, alternatively 0.05 to 0.1 wt % of the heterogeneous and/or homogeneous mixture.

The manufactured article. The manufactured article made from the homogeneous mixture may comprise a shaped form thereof. Examples are a coating on a substrate, a tape, a film, a layer of a laminate, a foam, and a pipe.

The coated conductor. The manufactured article may be the coated conductor, comprising a conductive core and a polymeric layer at least partially surrounding the conductive core, wherein at least a portion of the polymeric layer comprises the homogeneous mixture, or a cured polymer product of curing same. The entire polymeric layer, or only a portion of the layer, may comprise the cured polymer product.

The conductive core may be linear shape (e.g., like a wire) having a length and proximal and distal ends spaced apart from each other by the length of the linear shape; and the polymeric layer may surround the conductive core except for the proximal and distal ends.

The coated conductor may further comprise one or more additional polymeric layers, which independently may or may not comprise the cured polymer product; and/or an outer shielding layer (e.g., a metal sheath or sleeve). The coated conductor may comprise one or two insulation layers, at least one of which comprises the cured polymer product; alternatively or additionally one or two semiconductive layers, at least one of which comprises the cured polymer product containing a carbon black; alternatively or additionally an outer shielding layer, which comprises the cured polymer product.

High-density polyethylene or HDPE. A polyethylene homopolymer or poly(ethylene-co-1-alkene) copolymer having a density from 0.940 to 0.980 g/cm³, measured according to ASTM D792-13; wherein the 1-alkene comonomer is a (C₄-C₂₀)1-alkene such as a (C₄-C₈)1-alkene such as 1-butene, 1-hexene, or 1-octene.

Low-density polyethylene or LDPE. A poly(ethylene-co-1-alkene) copolymer having a density from 0.871 to less than 0.930 gram per cubic centimeter (g/cm³), measured according to ASTM D792-13; and having significantly lower amount of short chain branches per 1,000 carbon atoms (SCB/1000C) than does LLDPE, wherein SCB/1000C is determined according to the GPC and SCB test methods described later; wherein the 1-alkene comonomer is a (C₄-C₂₀)1-alkene such as a (C₄-C₈)1-alkene such as 1-butene, 1-hexene, or 1-octene.

Linear low-density polyethylene or LLDPE. A poly(ethylene-co-1-alkene) copolymer having a density from 0.871 to less than 0.930 g/cm³, measured according to ASTM D792-13; and having significant amount of short-chain branches per 1,000 carbon atoms (SCB/1000C), wherein SCB/1000C is determined according to the GPC and SCB test methods described later; wherein the 1-alkene comonomer is a (C₄-C₂₀)1-alkene such as a (C₄-C₈)1-alkene such as 1-butene, 1-hexene, or 1-octene.

LLDPEs are made under different process conditions than those used to make LDPEs. LLDPE is compositionally distinct from LDPE and has certain superior properties that have led it to replace LDPE in many commercial applications. These include coatings, films, sheets, and injection molded articles. LLDPE coatings include insulation layers of telecommunications cables. LLDPE films and sheets are used in packaging applications and non-packaging applications. Examples are agricultural film, food packaging, garment bags, grocery bags, heavy-duty sacks, industrial sheeting, pallet and shrink wraps and bags. LLDPE injection molded articles include buckets, freezer containers, lids, and toys.

Liquid means an amorphous state of matter at ambient temperature (e.g., 23° C.) that is intermediate between a gas and a solid and having a stable volume, but not a defined shape.

Liquid additive is used to describe the state of matter of the additive at the temperature of the heterogeneous mixture during the applying acoustic energy step, and does not necessarily require that the additive be a liquid at ambient temperature (e.g., 23° C.) if the temperature of the heterogeneous mixture during the applying acoustic energy step is greater than ambient temperature. In some aspects the liquid additive is a liquid at ambient temperature (e.g., at 23° C.). Solvents are not examples of liquid additives because solvents are used merely to dissolve a solid or liquid additive for contacting with the (A) polyolefin solids and/or the (B) organic peroxide, and are intended to be removed from heterogeneous mixture after the contacting step, or later removed from the homogeneous mixture before the homogeneous mixture is used to make a shaped article.

Maintaining temperature of a material below a threshold value. Any passive or active means of preventing how hot or cold the material is from rising to the threshold value. Passive maintaining means may comprise placing the material in a container (e.g., in an acoustic mixer device), wherein the temperature of the container less than the threshold value, and not exposing the container and its contents to a heating source. Active maintaining means may comprise thermally insulating the container or placing the container in effective cooling contact with a heat exchanger device that has a coolant fluid circulating therethrough.

Medium-density polyethylene or MDPE. A poly(ethylene-co-1-alkene) copolymer having a density from 0.930 to less than 0.940 g/cm³, measured according to ASTM D792-13; wherein the 1-alkene comonomer is a (C₄-C₂₀)1-alkene such as a (C₄-C₈)1-alkene such as 1-butene, 1-hexene, or 1-octene.

Melting means changing a material from a solid state of matter to a liquid state of matter. Typically, melting means the changing is complete such that the liquid state of matter contains no unmelted solid form of the material. The temperature of a material at which the material is to be characterized as a solid or a liquid is 20° C.

Polyolefin means any macromolecule comprising constituent units derived from polymerizing an olefin-functional monomer or copolymerizing at least two olefin-functional monomers, or a mixture of such macromolecules. The polyolefin may be amorphous (i.e., having a glass transition temperature but no melting point in differential scanning calorimetry (DSC)) or semi-crystalline (i.e., having a glass transition temperature and a melting point in DSC).

Solid means a state of matter at ambient temperature (e.g., 23° C.) that has a stable volume and defined shape. May be amorphous, crystalline, or semi-crystalline.

Any compound, composition, formulation, material, mixture, or reaction product herein may be free of any one of the chemical elements selected from the group consisting of: H, Li, Be, B, C, N, O, F, Na, Mg, Al, Si, P, S, Cl, K, Ca, Sc, Ti, V, Cr, Mn, Fe, Co, Ni, Cu, Zn, Ga, Ge, As, Se, Br, Rb, Sr, Y, Zr, Nb, Mo, Tc, Ru, Rh, Pd, Ag, Cd, In, Sn, Sb, Te, I, Cs, Ba, Hf, Ta, W, Re, Os, Ir, Pt, Au, Hg, TI, Pb, Bi, lanthanoids, and actinoids; with the proviso that chemical elements that are inherently required by the compound, composition, formulation, material, mixture, or reaction product (e.g., C and H required by a polyethylene, or C, H, and O required by an alcohol) are not omitted.

Alternatively precedes a distinct embodiment. ANSI is the American National Standards Institute organization headquartered in Washington, D.C., USA. ASME is the American Society of Mechanical Engineers, headquartered in New York City, N.Y., USA. ASTM is the standards organization, ASTM International, West Conshohocken, Pa., USA. Any comparative example is used for illustration purposes only and shall not be prior art. Free of or lacks means a complete absence of; alternatively not detectable. IUPAC is International Union of Pure and Applied Chemistry (IUPAC Secretariat, Research Triangle Park, N.C., USA). Periodic Table of the Elements is the IUPAC version of May 1, 2018. May confers a permitted choice, not an imperative. Operative means functionally capable or effective. Optional(ly) means is absent (or excluded), alternatively is present (or included). Properties may be measured using standard test methods and conditions. Ranges include endpoints, subranges, and whole and/or fractional values subsumed therein, except a range of integers does not include fractional values. Room temperature: 23°±1° C.

Unless stated otherwise, definitions of terms used herein are taken from the IUPAC Compendium of Chemical Technology (“Gold Book”) version 2.3.3 dated Feb. 24, 2014. Some definitions are given below for convenience.

Density: measured according to ASTM D792-13, Standard Test Methods for Density and Specific Gravity (Relative Density) of Plastics by Displacement, Method B (for testing solid plastics in liquids other than water, e.g., in liquid 2-propanol). Units of grams per cubic centimeter (g/cm³).

Melt Index (“I₂”): measured according to ASTM D1238-13, using conditions of 190° C./2.16 kg, formerly known as “Condition E”. Units of grams per 10 minutes (g/10 min.).

### EXAMPLES

Additional inventive embodiments are the preceding aspects, and the claims described later, that describe a range for a process condition and/or a range for a material property, wherein in the additional inventive embodiments an endpoint of the process condition range and/or an endpoint of the material property range, respectively, is amended to any one exemplified process condition value and/or any one exemplified material property value, respectively, described below in this section for any one inventive example.

Polyolefin solids (A)-1: a low-density poly(ethylene-co-1-hexene) copolymer having a unimodal molecular weight distribution, a density of 0.92 g/cc, and a melt index (I₂, 190° C., 2.16 kg) of 2 g/10 min. (“LDPE-1, 2 MI”). Used in the form of dry pellets.

Polyolefin solids (A)-2 (Prophetic): a low-density poly(ethylene-co-1-hexene) copolymer (LDPE-2) having a density of 0.92 g/cc and a melt index (I₂, 190° C., 2.16 kg) of 0.6 to 0.8 g/10 min. Used in the form of dry pellets.

Polyolefin solids (A)-3 (Prophetic): a low-density poly(ethylene-co-1-hexene) copolymer (LDPE-3) having a density of 0.922 to 0.924 g/cc and a melt index (I₂, 190° C., 2.16 kg) of 20 g/10 min. Used in the form of pellets.

Polyolefin solids (A)-4 (prophetic): a linear low-density polyethylene (LLDPE-1) that is a poly(ethylene-co-1-butene) copolymer having a unimodal molecular weight distribution, a density of 0.92 g/cc, and a melt index (I₂, 190° C., 2.16 kg) of 0.6 to 0.8 g/10 min. May be used in the form of dry pellets or dry granules. The granules may be as obtained from a gas phase polymerization reactor. The pellets are made from the reactor granules and are available as DFDA-7530 NT from The Dow Chemical Company. The pellets may be converted via granulation to granules. Granules were used in IE1 to IE4 (Table 1 below) and the pellets are used in prophetic example IE9 (Table 2 below).

Polyolefin solids (A)-5 (prophetic): a medium-density polyethylene (MDPE-1) that is a poly(ethylene-co-1-hexene) copolymer having a unimodal molecular weight distribution, a density of 0.930 to 0.940 g/cc, and a melt index (I₂, 190° C., 2.16 kg) of 0.7 to 0.9 g/10 min. DFH-3580 from The Dow Chemical Company. Used in the form of dry pellets.

Organic peroxide (B)-1: dicumyl peroxide (“DiCuP”).

Solid Antioxidant (C)-1: tris[(4-tert-butyl-3-hydroxy-2,6-dimethylphenyl)methyl]-1,3,5-triazine-2,4,6-trione (“TMTT”).

Solid Antioxidant (C)-2: distearyl thiodipropionate (“DSTDP”).

Solid Stabilizer (D)-1: a solid heat stabilizer that is N,N′-bisformyl-N,N′-bis(2,2,6,6-tetramethyl-4-piperidinyl)-hexamethylenediamine (“BBHMDA”).

Comparative Example 1 (CE1): prepared sample by melt-mixing (melt-compounding). In the conventional mixing process samples were made by first making intermediate formulations containing only constituents Polyolefin solids (A)-1, antioxidant (C)-1, antioxidant (C)-2, and heat stabilizer (D)-1. The experiments were conducted on a Brabender model Prep Mixer/Measuring Head laboratory electric batch mixer equipped with Cam Blades. The ingredients were fluxed at 120° C. for 3 minutes. The resulting mixture was then flattened, cooled and cut into strips. These were then fed into a single screw extruder to make wire strands, which were then cut into pellets. The unit consisted of a BRABENDER 1.9 cm (¾ inch) extruder with variable speed drive, a 24:1 Maddock mixing head screw, a BRABENDER strand die, lab water cooling trough with air wipe, a laser micrometer and a variable speed puller. The samples were extruded at 40 rotations per minute (rpm) screw speed and approximately 2.4 meters (8 feet) per minute take-up speed. Strands were made using a set temperature profile of 150° C./170° C./190° C./195° C. (across zone 1, zone 2, zone 3 and head/die) followed by pelletization at room temperature (e.g., 23° C.). The organic peroxide (B)-1, which was removed from a frozen sealed glass bottle, was placed inside a polyethylene bag, and put into a 60° C. water bath. The sample pellets were pre-heated in a large glass jar at 70° C. for 4 hours. After the pellet pre-heating step, the organic peroxide (B)-1 was pre-weighed to the specified amount and administered to the pellets using syringes. The jar of pellets was capped tightly and placed on the stone ware tumbler set at 30 rpm. After 5 minutes of tumbling, the jar was removed and manually shaken to loosen the pellets from the side of the jar. The organic peroxide soaking process continued for 8 to 10 hours at 70° C. The formulation of CE1 is reported later in Table 1.

Comparative Example 2 (CE2): made by physical mixing. A total of 150 g of the polyethylene granules (A)-1 were contacted with, and promptly physically mixed with, the organic peroxide (B)-1 (which had been removed from a frozen sealed glass bottle), and the additives antioxidant (C)-1, antioxidant (C)-2, and heat stabilizer (D)-1 in amounts shown later in Table 1 to make CE2 as a physical mixture of (A)-1, (B)-1, (C)-1, (C)-2, and (D)-1. CE2 was promptly tested for cure properties, and the results are also shown in Table 1. The cure properties showed that the physical mixture of CE2 had failed to undergo crosslinking, i.e., had a lack of crosslinks. Because there was no crosslinking there was no reason to perform mechanical testing of CE2.

Inventive Example 1 (IE1): an inventive example was made by acoustic mixing. A total of 150 g of polyethylene granules (A)-1 were contacted with organic peroxide (B)-1, which was removed from a frozen sealed glass bottle, additives antioxidant (C)-1, antioxidant (C)-2, and heat stabilizer (D)-1 in amounts shown in Table 1 to make heterogeneous mixture of IE1. Acoustic energy was applied to the heterogeneous mixtures using a Resodyn™ Acoustic Mixer (LabRAM Mixer) at 23° to 26° C. for 3 minutes in a glass jar at a frequency of 60 hertz (Hz) to separately make the homogeneous mixture of IE1. Multiple batches of the homogeneous mixture were made so as to have enough material properties testing and for extruding onto wires. The inventive homogeneous mixtures were separately extruded using a 1.9 cm (¾ inch) Brabender extruder, 25-1 LID, with Maddox mixing head screw, using a strand die. The temperature profile of the extruder was set at 150° C./170° C./180° C./190° C. and the screw speed was 40 rpm. The strands were pelletized at room temperature for further processing to separately give the homogeneous mixture of IE1 as pellets. Formulation is reported later in Table 1.

Cure Properties Test Method. Moving Die Rheometer analyses were performed on samples of IE1 and CE1 using Alpha Technologies Rheometer MDR model 2000 unit. Testing was based on ASTM D5289-12, Standard Test Method for Rubber Property—Vulcanization Using Rotorless Cure Meters. The MDR analyses were performed using 4 to 5 grams of material. Samples were tested at 182° C. for 15 minutes at 0.5 degrees arc oscillation, while monitoring change in torque. Designate the lowest measured torque value as “ML”, expressed in deciNewton-meter (dN-m). As curing or crosslinking progresses, the measured torque value increases, eventually reaching a maximum torque value. Designate the maximum or highest measured torque value as “MH”, expressed in dN-m. All other things being equal, the greater the MH torque value, the greater the extent of crosslinking. Determine the amount of total crosslinking as being the difference MH minus ML (MH-ML). The greater the difference MH-ML, the greater the amount of crosslinking. Measured in pound-inches (lb.-in.), and converted to Newton-meter (N-m), wherein 1.00 lb.-in.=0.113 N-m.

Mechanical Properties Test Method. Compression molded plaques of the comparative mixture of CE1 and the homogeneous mixture of IE1 were prepared to use as specimens for ultimate tensile strength and elongation-at-break (T & E) testing. The pelleted homogeneous mixtures were separately compression molded using a WABASH Genesis Steam press (with quench cooling capability) operated in the manual mode. The press was preheated to 115°±5° C. A total of 75 grams of pellets were pre-weighed and placed in the center of a 1.9 mm (75 mils) stainless steel plaque between the mold assembly made up of mylar and aluminum sheets. The resulting filled mold was then placed into the press at 2.1 megapascals (Mpa, 300 pounds per square inch (psi)) for 3 minutes. After this initial press, the temperature was increased to 185°±5° C. for 2 minutes. Then the pressure was increased to 17.2 Mpa (2,500 psi) for 15 minutes. Switching from steam to water occurred 15 seconds prior to the end of the 15 minutes period, and the samples were quench cooled for 5 minutes. The cooled samples were taken out after they reached 35° C. to give the compression molded plaques (dimensions 0.20×0.20×1.9 mm) (8×8×75 mils)) of IE1 and CE1. Three plaques were made from IE1 and three from CE1. From the plaques were cut 5 Type IV dog-bones, where were tensile tested per ASTM D638-03 after first being conditioned for 48 hours in a controlled air atmosphere at 23.0° C. (73.4 degrees Fahrenheit (° F.)) with 50% relative humidity. The tensile strength and elongation-at-break testing were conducted on an Instron Renew 4201 65/16 apparatus using a 50.8 cm per minute (20 inches per minute) jaw separation speed with a 45 kilogram (kg, 100 pound) load cell. Mechanical property testing was conducted on compression molded plaque specimens that were not heat aged and on specimens after being heat aged. The greater the tensile strength value the greater the maximum amount of stress a material can withstand without stretching or breaking. The lower the elongation-at-break value, the lesser the amount of stretching a test material can undergo before breaking. Data are reported below in Table 1.

TABLE 1
Homogeneous Mixtures and Properties of Examples.

| Homogeneous Mixtures | | | |
|---|---|---|---|
| (wt %) (* melt | | | |
| compounded/soaked | | | |
| or \hat{ } acoustic mixed) | CE1* | CE2 | IE1\hat{ } |
| Polyolefin Solids | 97.93 | 97.73 | 97.73 |
| (A)-1 (LLDPE-1,2 MI) | | | |
| Solid Organic Peroxide | 1.8 | 1.8 | 1.9 |
| (B)-1 (DiCuP) | | | |
| Solid Antioxidant | 0.14 | 0.14 | 0.14 |
| (C)-1 (TMTT) | | | |
| Solid Antioxidant | 0.23 | 0.23 | 0.23 |
| (C)-2 (DSTDP) | | | |
| Solid Stabilizer | 0.006 | 0.006 | 0.006 |
| (D)-1 (BBHMDA) | | | |
| Total (wt %) | 100.0 | 100.0 | 100.0 |

Cure Properties

| | | | |
|---|---|---|---|
| MH, N-m (lb-in) | 0.36 (3.2) | 0.022 (0.2) | 0.38 (3.4) |
| ML, N-m (lb-in) | 0.05 (0.4) | 0.018 (0.16) | 0.03 (0.3) |
| MH-ML, N-m (lb-in) | 0.31 (2.8) | 0.004 (0.04) | 0.35 (3.1) |

Mechanical Properties

| | | | |
|---|---|---|---|
| Tensile stress, Mpa | 22.3 (3230) | N/m | 20.4 (2960) |
| (psi) (no heat aging) | | | |
| Elongation-at-break | 559 | N/m | 506 |
| (%) (no heat aging) | | | |

N/m not measured. N/a not applicable. N/r not reported.

As shown by comparing the data for IE1 with those for CE1 In Table 1, these cure and mechanical properties characterizations show that the inventive homogeneous mixture may be prepared rapidly (in less than 10 minutes, e.g., 3 minutes) under mild temperatures (e.g., <30° C., e.g., 23° to 26° C.) and achieve loading levels of the (B) organic peroxide that are typically used for curing of polyolefins. Further, the inventive homogeneous mixture may be cured to give cure properties and mechanical properties that are improved relative those obtained from a comparative example that is made by a conventional two-step process comprising melt-blending polyolefin solids with all additives (except for organic peroxide) at 120° C. to give the an intermediate blend, then extruding strands thereof at 150° C./170° C./190° C./195° C., pelletizing, and soaking organic peroxide into the pellets at elevated temperature (70° C.) for an extended period of time (8 to 10 hours). In fact as indicated by a lower starting ML value and an ultimate MH value, a higher MH-ML value, obtained by curing the inventive homogeneous mixture using a moving die rheometer, it can be concluded that the inventive acoustic mixing method decreases organic peroxide decomposition during preparation of the inventive homogeneous mixture relative to the preparation of the comparative melt blend/soaked mixture. As a result, it can also be seen that a greater extent of crosslinking of the inventive homogeneous mixture is achieved relative to that of the comparative melt-blend/soaked mixture. This inventive advantage is also reflected in the inventive cured product having a lower elongation-at-break value (i.e., higher crosslinking) than the comparative cured product.

As shown by the data for CE2 in Table 1, no mechanical testing was carried out on CE2 because the samples cure properties showed a lack of crosslinking. This result for CE2 demonstrates that a comparative method comprising mechanical or physical mixing (A) polyolefin solids and (B) organic peroxide without either melting the (A) polyolefin solids or allowing time for the (B) organic peroxide to soak into unmelted (A) polyolefin solids is a challenge that is solved by the present method comprising applying acoustic energy to achieve acoustic mixing.

(Prophetic) Making a coated conductor. The pelletized inventive homogeneous mixture of IE1 is introduced into a wire coating extrusion line to make a coated wire of having a coating consisting essentially of IE1, or a crosslinked product made by curing thereof, as wire constructions on 14 AWG solid copper wire. The wire coating extrusion line consists of a BRABENDER 1.9 cm extruder with variable speed drive, a 25:1 standard PE screw, a BRABENDER cross-head wire die, lab water cooling trough with air wipe, a laser micrometer and a variable speed wire puller. The sample is extruded at 40 rpm screw speed with 0.76 millimeter (mm, 30 mils) wall thickness. A wire is made using a set temperature profile of 160°/170° C./180° C./190° C. across zone 1/zone 2/zone 3/and head/die, respectively, at a take-up speed of 3.1 meters per minute (10 feet per minute). The coating on the wire consists essentially of the homogeneous mixture of IE1 of a crosslinked product of curing the homogeneous mixture of IE1. If desired the wire may be passed through a vulcanization tube set at a cure temperature of 220° C. to fully cure the homogeneous mixture to give a wire having a coating thereon wherein the coating consists essentially of a crosslinked product of IE1.

1. A method of making a homogeneous mixture of polyolefin solids and organic peroxide without melting the polyolefin solids during the making, the method comprising applying acoustic energy at a frequency of from 20 to 100 hertz (Hz) to a heterogeneous mixture comprising (A) polyolefin solids and (B) organic peroxide for a period of time sufficient to substantially intermix the (A) polyolefin solids and the (B) organic peroxide together while maintaining temperature of the heterogeneous mixture (and, for that matter, the temperature of the homogeneous mixture made therefrom) below the melting temperature of the (A) polyolefin solids, thereby making the homogeneous mixture without melting the (A) polyolefin solids; wherein the (A) polyolefin solids are from 95.0 to 99.9 weight percent (wt %) and the (B) organic peroxide is from 0.1 to 5.0 wt %, respectively, of the combined weights of the constituents (A) and (B).

2. The method of claim 1 wherein the applying acoustic energy step is characterized by any one of limitations (i) to (v): (i) the frequency is from 50 to 70 Hz; (ii) the period of time is from 0.5 minute to 4 hours; (iii) both (i) and (ii); (iv) the maintaining temperature of the heterogeneous mixture below the melting temperature of the (A) polyolefin solids comprises maintaining temperature of the heterogeneous mixture at from −20° to 109° C.; and (v) both (iv) and any one of (i) to (iii).

3. The method of claim 1 wherein the (A) polyolefin solids are characterized by a physical form (i.e., solid particulate form) that is a powder, granules, pellets, or a blend of any two or more thereof, and by a melting temperature that is from 61° to 180° C.; and the (B) organic peroxide is a liquid organic peroxide or a solid organic peroxide.

4. The method of claim 1 wherein the polyolefin of the (A) polyolefin solids consists essentially of one or more ethylene-based polymers; wherein each ethylene-based polymer is a low-density polyethylene (LDPE) polymer or a combination of the LDPE polymer and a polyolefin selected from the group consisting of: a second LDPE polymer; a linear low-density polyethylene polymer; and a high-density polyethylene polymer. In other embodiments the polyolefin of the (A) polyolefin solids consists essentially of an LDPE and a polypropylene polymer.

5. The method of claim 1 wherein the organic peroxide is a solid organic peroxide.

6. The method of claim 1 wherein the heterogeneous mixture further comprises one or more additives that is/are not the (A) polyolefin solids or the (B) organic peroxide, and the applying acoustic energy step comprises applying acoustic energy at a frequency of from 20 to 100 hertz (Hz) to the heterogeneous mixture comprising the (A) polyolefin solids, the (B) organic peroxide, and the one or more additives that do not include a peroxide for a period of time sufficient to substantially intermix (thoroughly or completely homogenize) the (A) polyolefin solids, the (B) organic peroxide, and the one or more additives together while maintaining temperature of the heterogeneous mixture below the melting temperature of the (A) polyolefin solids, thereby making the homogeneous mixture further comprising the one or more additives, without melting the (A) polyolefin solids.

7. The method of claim 6 wherein at least one of the one or more additives that is not constituents (A) or (B) is independently a liquid additive or particulate solid additive independently selected from additives (C) to (D): a liquid or particulate solid (C) antioxidant; and a liquid or particulate solid (D) stabilizer for stabilizing the homogeneous mixture against effects of ultraviolet light and/or heat.

8. The method of claim 7 wherein the one or more additives include one or more of solid antioxidant (C)-1: tris[(4-tert-butyl-3-hydroxy-2,6-dimethylphenyl)methyl]-1,3,5-triazine-2,4,6-trione; solid antioxidant (C)-2: distearyl thiodipropionate; and solid stabilizer (D)-1: N,N′-bisformyl-N,N′-bis(2,2,6,6-tetramethyl-4-piperidinyl)-hexamethylenediamine.

9. The method of claim 1 further comprising, before the applying acoustic energy step, a step of melting the (A) polyolefin solids to make a melt thereof, and mechanically blending the melt of (A) with one or more additives that are not (B) organic peroxide to give a melt mixture that is free of (B) organic peroxide; shaping the melt mixture to give a shaped melt mixture; and cooling the shaped melt mixture to give the (A) polyolefin solids containing one or more additives; and combining the (A) polyolefin solids containing one or more additives with the (B) organic peroxide to give the heterogeneous mixture.

10. The method of claim 1 further comprising curing the homogeneous mixture to give a crosslinked homogeneous product.
